(19) United States
(12) Patent Application Publication
(10) Pub. No.: US 2026/0064141 A1
(43) Pub. Date: Mar. 5, 2026

(54) METHOD OF DETERMINING TEMPERATURE MODEL OF SUSCEPTOR AND AEROSOL-GENERATING DEVICE PERFORMING THE METHOD

(71) Applicant: KT&G CORPORATION, Daejeon (KR)

(72) Inventors: Jae Min LEE, Siheung-si (KR); Sang Kyu PARK, Seoul (KR); Sang Joon KIM, Yongin-si (KR); Se Hwan JUNG, Anyang-si (KR)

(73) Assignee: KT&G CORPORATION, Daejeon (KR)

(21) Appl. No.: 19/248,778

(22) Filed: Jun. 25, 2025

(30) Foreign Application Priority Data
Aug. 29, 2024 (KR) 10-2024-0116834
Nov. 7, 2024 (KR) 10-2024-0157171

(51) Int. Cl. G05D 23/26; A24F 40/465; A24F 40/51; A24F 40/57; G01K 7/36; H05B 6/06; H05B 6/10

(52) U.S. Cl. CPC G05D 23/26; A24F 40/465; A24F 40/51; A24F 40/57; G01K 7/36; H05B 6/06; H05B 6/105

(57) ABSTRACT

A method, performed by an aerosol-generating device, of determining a temperature model of a susceptor, includes applying a first signal having a first frequency to a coil of a heater so that an alternating magnetic field is generated, determining a first value of an electrical characteristic of a susceptor indicated by the first signal, applying a second signal having a second frequency to the coil of the heater so that an alternating magnetic field is generated, determining a second value of the electrical characteristic of the susceptor indicated by the second signal, and determining a first temperature model for the susceptor based on the first value and the second value, wherein the first temperature model may be a model used for determining a temperature of the susceptor based on the electrical characteristic of the susceptor.

### CROSS-REFERENCE TO RELATED APPLICATION

This application claims the benefit of Korean Patent Application No. 10-2024-0116834 filed on Aug. 29, 2024, and Korean Patent Application No. 10-2024-0157171 filed on Nov. 7, 2024, in the Korean Intellectual Property Office, the entire disclosures of which are incorporated herein by reference for all purposes.

### BACKGROUND

### 1. Field of the Invention

The following embodiments relate to a technology for controlling an aerosol-generating device, and more particularly, to a technology for estimating a temperature of a susceptor in an induction heating type aerosol-generating device.

### 2. Description of the Related Art

The demand for electronic cigarettes, or e-cigarettes, has recently been on the rise. The rising demand for e-cigarettes has accelerated the continued development of e-cigarette-related functions. The e-cigarette-related functions may include, for example, functions according to the types and characteristics of e-cigarettes.

Typically, to heat a cigarette using an inductive heating scheme, an e-cigarette may use a coil to generate an alternating magnetic field to generate eddy currents in a susceptor adjacent to the cigarette. The temperature of the susceptor may increase due to eddy currents generated in the susceptor. To control the temperature of the susceptor in response to a user's smoking, a temperature model to estimate the temperature of the susceptor may be required.

### SUMMARY

An embodiment may provide an aerosol-generating device capable of estimating a temperature of a susceptor based on electrical characteristics of the susceptor.

An embodiment may provide an aerosol-generating device capable of detecting replacement of a susceptor based on electrical characteristics of the susceptor.

However, technical goals are not limited to the technical goals described above, and other technical goals may exist.

According to an aspect, there is provided a method, performed by an aerosol-generating device, of determining a temperature model of a susceptor, including applying a first signal having a first frequency to a coil of a heater so that an alternating magnetic field is generated, determining a first value of an electrical characteristic of a susceptor indicated by the first signal, applying a second signal having a second frequency to the coil of the heater so that an alternating magnetic field is generated, determining a second value of the electrical characteristic of the susceptor indicated by the second signal, and determining a first temperature model for the susceptor based on the first value and the second value, wherein the first temperature model may be a model used for determining a temperature of the susceptor based on the electrical characteristic of the susceptor.

According to another aspect, there is provided an aerosol-generating device including an induction coil configured to generate an alternating magnetic field, and a controller configured to control the aerosol-generating device, wherein the controller is further configured to, apply a first signal having a first frequency to a coil of a heater so that an alternating magnetic field is generated, determine a first value of an electrical characteristic of a susceptor indicated by the first signal, apply a second signal having a second frequency to the coil of the heater so that an alternating magnetic field is generated, determine a second value of the electrical characteristic of the susceptor indicated by the second signal, and determine a first temperature model for the susceptor based on the first value and the second value, wherein the first temperature model may be a model used for determining a temperature of the susceptor based on the electrical characteristic of the susceptor.

Additional aspects of embodiments will be set forth in part in the description which follows and, in part, will be apparent from the description, or may be learned by practice of the disclosure.

According to at least one of the embodiments of the present disclosure, an aerosol-generating device capable of determining a temperature model for estimating a temperature of a susceptor based on a magnitude of an eddy current of the susceptor indicated by a signal of a predetermined frequency may be provided.

According to at least one of the embodiments of the present disclosure, an aerosol-generating device capable of determining a temperature model of a susceptor when an input occurs in which a susceptor is mounted and detecting replacement of the susceptor when the determined temperature model differs from a previous temperature model may be provided.

### BRIEF DESCRIPTION OF THE DRAWINGS

These and/or other aspects, features, and advantages of the present disclosure will become apparent and more readily appreciated from the following description of embodiments, taken in conjunction with the accompanying drawings of which:

FIG. 1 is a block diagram of an aerosol-generating device according to one embodiment;

FIG. 2 shows an aerosol-generating device according to one embodiment;

FIG. 3 shows an aerosol-generating device according to one embodiment;

FIG. 4 shows an aerosol-generating device according to one embodiment;

FIG. 5 is a flowchart of a method of determining a temperature model of a susceptor, according to one embodiment;

FIG. 6 shows trajectories of eddy currents in a susceptor as indicated by a frequency of a signal, according to one embodiment;

FIG. 7 is a flowchart of a method of determining an electrical characteristic of a susceptor, according to one embodiment;

FIG. 8 is a flowchart of a method of determining a temperature model of a susceptor based on a temperature of a sensor, according to one embodiment;

FIG. 9 shows a temperature model of a susceptor based on a magnitude of a current, according to one embodiment;

FIG. 10 is a flowchart of a method of calculating a temperature of a susceptor based on a temperature model of the susceptor, according to one embodiment;

FIG. 11 is a flowchart of a method of updating a temperature model of a susceptor according to one embodiment;

FIG. 12 is a flowchart of a method of determining a second temperature model for a susceptor according to one embodiment;

FIG. 13 is a flowchart of a method of receiving an input to update a temperature model of a susceptor, according to one embodiment;

FIG. 14 is a flowchart of a method of discarding a second temperature model or updating a first temperature model to the second temperature model, according to one embodiment; and

FIG. 15 is a flowchart of a method of detecting change of a susceptor according to one embodiment.

### DETAILED DESCRIPTION

Hereinafter, the embodiments disclosed in the present specification will be described in detail with reference to the accompanying drawings. The same or similar elements are denoted by the same reference numerals even though they are depicted in different drawings, and redundant descriptions thereof will be omitted. With regard to the description of the drawings, similar reference numerals may be used to refer to similar or related elements.

In the following description, with respect to constituent elements used in the following description, the suffixes “module” and “unit” are used only in consideration of facilitation of description, and do not have mutually distinguished meanings or functions. As used herein, the suffix “module” or “unit” may include a unit implemented in hardware, software, or firmware, and may be used interchangeably with other terms, for example, “logic,” “logic block,” “part,” or “circuitry.” A “module” or a “unit” may be a single integral component, or a minimum unit or part thereof, adapted to perform one or more functions. For example, the “module” or the “unit” may be implemented in the form of an application-specific integrated circuit (ASIC).

In addition, in the following description of the embodiments disclosed in the present specification, a detailed description of known functions and configurations incorporated herein will be omitted when the same may make the subject matter of the embodiments disclosed in the present specification rather unclear. In addition, the accompanying drawings are provided only for a better understanding of the embodiments disclosed in the present specification and are not intended to limit the technical ideas disclosed in the present specification. Therefore, it should be understood that the accompanying drawings include all modifications, equivalents, and substitutions within the scope and spirit of the present disclosure.

It will be understood that although the terms “first”, “second”, etc., may be used herein to describe various components, these components should not be limited by these terms. These terms are only used to distinguish one component from another component.

It will be understood that when a component is referred to as being “connected to” or “coupled to” another component, it may be directly connected to or coupled to another component, or intervening components may be present. On the other hand, when a component is referred to as being “directly connected to” or “directly coupled to” another component, there are no intervening components present.

As used herein, the singular form is intended to include the plural forms as well, unless the context clearly indicates otherwise.

Embodiments as set forth herein may be implemented as software including one or more instructions that are stored in a storage medium (e.g., a memory 17) that is readable by a machine (e.g., the aerosol-generating device 1). For example, a processor (e.g., the controller 12) of the machine (e.g., the aerosol-generating device 1) may invoke at least one of the one or more instructions stored in the storage medium, and may execute the same. This allows the machine to be operated to perform at least one function according to the at least one instruction invoked. The one or more instructions may include code generated by a compiler or code executable by an interpreter. The machine-readable storage medium may be provided in the form of a non-transitory storage medium. Here, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

In the present disclosure, the directions of the aerosol-generating device 1 may be defined based on the orthogonal coordinate system. In the orthogonal coordinate system, the x-axis direction may be defined as a leftward-rightward direction of the aerosol-generating device 1. The y-axis direction may be defined as a forward-backward direction of the aerosol-generating device 1. The z-axis direction may be defined as an upward-downward direction of the aerosol-generating device 1.

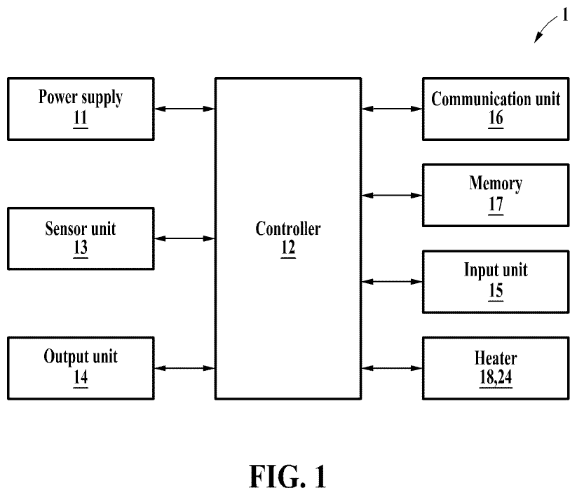

FIG. 1 is a block diagram of an aerosol-generating device according to one embodiment.

According to one embodiment, the aerosol-generating device 1 may include a power supply 11, a controller 12, a sensor unit 13, an output unit 14, an input unit 15, a communication unit 16, a memory 17, and/or a heater 18 and 24. However, the components included in the aerosol-generating device 1 are not limited to those shown in FIG. 1. That is, it will be understood by those skilled in the art related to the present embodiment that some of the components shown in FIG. 1 may be omitted or new components may be further included depending on the design of the aerosol-generating device 1.

According to one embodiment, the sensor unit 13 may detect the state of the aerosol-generating device 1 or the state of the surroundings of the aerosol-generating device 1, and may transmit the detected information to the controller 12. For example, the sensor unit 13 may include a temperature sensor, a puff sensor, an insertion detection sensor, a reuse detection sensor, an overly moist state detection sensor, a cigarette identification sensor, a cartridge detection sensor, a cap detection sensor, and/or a movement detection sensor. Meanwhile, the sensor unit 13 may further include various sensors, such as a liquid residual quantity sensor for detecting the residual quantity of liquid in the cartridge and an immersion sensor for detecting immersion of the aerosol-generating device 1.

According to one embodiment, the temperature sensor may detect a temperature to which the heater 18 and 24 is heated. The aerosol-generating device 1 may include a separate temperature sensor for detecting the temperature of the heater 18 and 24, or the heater 18 and 24 itself may serve as a temperature sensor. In an example, the temperature sensor may be used to measure impedance for the heater 18. The impedance for the heater 18 may correlate with the temperature of the heater 18. The temperature sensor may measure current and/or voltage applied to the heater 18 (or an induction coil). The impedance for the heater 18 may be obtained based on the measured current and/or voltage. The controller 12 may estimate the temperature of the heater 18 based on the obtained impedance.

In an example, the temperature sensor may include a resistance element (e.g., a thermistor), the resistance value of which varies in response to changes in the temperature of the heater 18 and 24. The temperature sensor may output a signal corresponding to the resistance value of the resistance element, and the controller 12 may determine the temperature of the heater 18 and 24 and/or a change in the temperature of the heater 18 and 24 based on the signal corresponding to the resistance value.

In another example, the temperature sensor may include a sensor that detects the resistance value of the heater 18 and 24. The temperature sensor may output a signal corresponding to the resistance value of the heater 18 and 24, and the controller 12 may determine the temperature of the heater 18 and 24 and/or a change in the temperature of the heater 18 and 24 based on the signal corresponding to the resistance value.

According to one embodiment, the temperature sensor may detect the temperature of the power supply 11. The temperature sensor may be disposed adjacent to the power supply 11. For example, the temperature sensor may be attached to one surface of the power supply 11 (e.g., a battery) and/or may be mounted on one surface of a printed circuit board. In an example, the aerosol-generating device 1 may include a power supply protection circuit module (PCM), and the temperature sensor may be disposed adjacent to the power supply 11 together with the power supply protection circuit module.

According to one embodiment, the temperature sensor may be disposed in a housing (not shown) of the aerosol-generating device 1 to detect the internal temperature of the housing (not shown).

According to one embodiment, the puff sensor may detect a user's puff.

In an example, the puff sensor may include a pressure sensor. The pressure sensor may output a signal corresponding to the internal pressure of the aerosol-generating device 1, and the controller 12 may determine the user's puff based on the signal corresponding to the internal pressure. Here, the internal pressure of the aerosol-generating device 1 may correspond to the pressure of an airflow path through which gas flows. The puff sensor may be disposed corresponding to the airflow path through which gas flows in the aerosol-generating device 1.

In another example, the puff sensor may include a temperature sensor. When the user's puff occurs, temperature drop may temporarily occur in the airflow path, a space into which an aerosol-generating article is inserted (hereinafter referred to as an “insertion space”), and the heater 18 and 24. The controller 12 may determine the user's puff based on a signal corresponding to the temperature of the airflow path output from the temperature sensor.

In still another example, the puff sensor may include both a pressure sensor and a temperature sensor. In this case, the temperature sensor may measure temperature used to calibrate the internal pressure measured by the pressure sensor. In one example, the puff sensor may calibrate a signal corresponding to the internal pressure based on the temperature measured by the temperature sensor, and may output the calibrated signal. In another example, the puff sensor may output a signal corresponding to the temperature measured by the temperature sensor and a signal corresponding to the internal pressure measured by the puff sensor. In this case, the controller 12 may receive the signals, and may calibrate the signal corresponding to the internal pressure based on the signal corresponding to the temperature.

In still another example, the puff sensor may include a capacitance sensor. The capacitance sensor may also be called a cap sensor or a capacitive sensor. When the user's puff occurs, a temperature change and/or aerosol flow may occur in the insertion space of the aerosol-generating article, and accordingly, a dielectric constant in the insertion space may change. The controller 12 may determine the user's puff based on a signal corresponding to the dielectric constant in the insertion space output from the capacitance sensor.

The puff sensor is not limited to the examples described above, and may be implemented as various sensors for detecting the user's puff.

According to one embodiment, the insertion detection sensor may detect insertion and/or removal of the aerosol-generating article. The insertion detection sensor may be mounted adjacent to the insertion space. In addition, the insertion detection sensor may include any combination of the examples described above.

In an example, the insertion detection sensor may include a capacitance sensor. The capacitance sensor may include at least one conductor, and the at least one conductor may be disposed adjacent to the insertion space. When the aerosol-generating article is inserted into or removed from the insertion space, capacitance around the conductor may change. The controller 12 may determine insertion and/or removal of the aerosol-generating article based on a signal corresponding to the dielectric constant in the insertion space output from the capacitance sensor.

In another example, the insertion detection sensor may include an inductive sensor. The inductive sensor may include at least one coil, and the at least one coil may be disposed adjacent to the insertion space. If the aerosol-generating article (e.g., a wrapper of the aerosol-generating article) includes a conductor, when the aerosol-generating article is inserted into or removed from the insertion space, a change in magnetic field may occur around the coil through which current flows. The controller 12 may determine insertion and/or removal of the aerosol-generating article including a conductor based on the characteristics of the current output from or detected by the inductive sensor (e.g., frequency of alternating current, a current value, a voltage value, an inductance value, and an impedance value). Alternatively, a susceptor SUS or the like may be included in the aerosol-generating article (e.g., a medium portion of the aerosol-generating article). In this case, a change in magnetic field may also occur around the coil based on insertion or removal of the susceptor or the like into or from the insertion space, and the controller 12 may determine insertion and/or removal of the aerosol-generating article based on the characteristics of the current of the inductive sensor.

The insertion detection sensor is not limited to the examples described above, and may be implemented as various sensors (e.g., a proximity sensor) for detecting insertion and/or removal of the aerosol-generating article. In addition, the insertion detection sensor may include any combination of the examples described above. According to one embodiment, the insertion detection sensor may include a switch or the like for detecting pressing by the aerosol-generating article.

According to one embodiment, the reuse detection sensor may detect whether the aerosol-generating article is being reused. In an example, the reuse detection sensor may be a color sensor for detecting the color of the aerosol-generating article. If the aerosol-generating article is used by the user, a change in the color of a portion of the wrapper may occur due to the generated aerosol or heating. The color sensor may output a signal corresponding to an optical characteristic (e.g., wavelength of light) corresponding to the color of the wrapper based on the light reflected from the wrapper. When a change in the color of a portion of the wrapper is detected, the controller 12 may determine that the aerosol-generating article inserted into the insertion space has already been used.

According to one embodiment, the overly moist state detection sensor may detect whether the aerosol-generating article is in an overly moist state. For example, the overly moist state detection sensor may include a capacitance sensor. The capacitance sensor may include at least one conductor disposed adjacent to the insertion space. The controller 12 may determine whether the aerosol-generating article is in an overly moist state based on the level of a signal corresponding to the dielectric constant or the like output from the capacitance sensor. In an example, the controller 12 may check a level range within which the level of the signal is included based on a look-up table, and may determine the moisture content of the aerosol-generating article based on the checked level range.

According to one embodiment, the cigarette identification sensor may detect whether the aerosol-generating article is authentic and/or may detect the type of the aerosol-generating article.

In an example, the cigarette identification sensor may include an optical sensor for detecting an identification material (or an identification mark) located on the outer surface (e.g., the wrapper) of the aerosol-generating article. The optical sensor may radiate light toward the identification material (or the identification mark) of the aerosol-generating article, and may detect whether the aerosol-generating article is authentic and/or may detect the type of the aerosol-generating article based on the reflected light. For example, the identification material may include a material (i.e., a luminous material) that emits light of a specific wavelength band based on the light radiated thereto. The controller 12 may determine whether the aerosol-generating article is authentic and/or may determine the type of the aerosol-generating article based on the range of the wavelength.

In another example, the cigarette identification sensor may include a capacitance sensor. The dielectric constant in the insertion space may vary depending on the type of the aerosol-generating article inserted into the insertion space. The controller 12 may determine whether the aerosol-generating article is authentic and/or may determine the type of the aerosol-generating article based on a signal corresponding to the dielectric constant or the like in the insertion space output from the capacitance sensor.

In still another example, the cigarette identification sensor may include an inductive sensor. If a conductor is included in the wrapper and/or inner portion (e.g., the medium portion) of the aerosol-generating article inserted into the insertion space, when the aerosol-generating article is inserted into the insertion space, the characteristics of the current detected by the inductive sensor (e.g., frequency of alternating current, a current value, a voltage value, an inductance value, and an impedance value) may vary depending on the type of the aerosol-generating article inserted into the insertion space. The controller 12 may determine whether the inserted aerosol-generating article is authentic and/or may determine the type of the inserted aerosol-generating article based on the characteristics of the current output from or detected by the inductive sensor.

The cigarette identification sensor is not limited to the examples described above, and may be implemented as various sensors for detecting whether the aerosol-generating article is authentic and/or detecting the type of the aerosol-generating article. In addition, the cigarette identification sensor may include any combination of the examples described above.

According to one embodiment, the cartridge detection sensor may detect mounting and/or removal of the cartridge. For example, the cartridge detection sensor may include an inductive sensor, a capacitance sensor, a resistance sensor, a Hall sensor (Hall IC), and/or an optical sensor.

According to one embodiment, the cap detection sensor may detect mounting and/or removal of the cap. For example, the cap detection sensor may include an inductive sensor, a capacitance sensor, a resistance sensor, a contact sensor, a Hall sensor (Hall IC), and/or an optical sensor. The cap may cover at least a portion of the cartridge mounted in or inserted into the aerosol-generating device 1 or may cover at least a portion of the housing of the aerosol-generating device 1. When the cap is mounted in or removed from the housing, the cap detection sensor may output a signal corresponding to mounting or removal, and the controller 12 may determine mounting or removal of the cap based on the signal corresponding to mounting or removal.

According to one embodiment, the movement detection sensor may detect movement of the aerosol-generating device 1. The movement detection sensor may be implemented as at least one of an acceleration sensor or a gyro sensor.

According to one embodiment, the sensor unit 13 may further include at least one of a humidity sensor, an air pressure sensor, a magnetic sensor, a position sensor (global positioning system (GPS)), or a proximity sensor in addition to the sensors described above. The functions of the sensors can be intuitively deduced by those skilled in the art from the names thereof, and thus detailed descriptions thereof may be omitted.

According to one embodiment, the output unit 14 may output information about the state of the aerosol-generating device 1 to provide the same to the user. The output unit 14 may include, but is not limited to, a display, a haptic unit, and/or a sound output unit. For example, information about the aerosol-generating device 1 may include a charging/discharging state of the power supply 11 of the aerosol-generating device 1, a preheating state of the heater 18 and 24, an insertion/removal state of the aerosol-generating article and/or the cartridge, a mounting/removal state of the cap, or a state in which the use of the aerosol-generating device 1 is restricted (e.g., detection of an abnormal object). The display may visually provide the information about the state of the aerosol-generating device 1 to the user. For example, the display may include a light-emitting diode (LED), a liquid crystal display panel (LCD), and an organic light-emitting diode panel (OLED). If the display includes a touchpad, the display may also be used as the input unit 15. The haptic unit may haptically provide the information about the aerosol-generating device 1 to the user. For example, the haptic unit may include a vibration motor, a piezoelectric element, and an electrical stimulation device. The sound output unit may audibly provide the information about the aerosol-generating device 1 to the user. For example, the sound output unit may convert an electrical signal into an acoustic signal and may output the acoustic signal to the outside.

According to one embodiment, the power supply 11 may supply power used for operation of the aerosol-generating device 1. The power supply 11 may include one or more batteries. The power supply 11 may supply power so that the heater 18 and 24 is heated. In addition, the power supply 11 may supply power necessary for operation of the other components included in the aerosol-generating device 1, such as the controller 12, the sensor unit 13, the output unit 14, the input unit 15, the communication unit 16, and the memory 17. The power supply 11 may be a rechargeable battery or a disposable battery. For example, the power supply 11 may be a lithium polymer (LiPoly) battery without being limited thereto. The power supply 11 may be a replaceable (separation-type) battery (hereinafter referred to as a “removable battery”). The removable battery may be mounted in a battery accommodation portion provided in the aerosol-generating device 1 or may be removed from the battery accommodation portion. The removable battery may be charged in a wired and/or wireless manner.

According to one embodiment, the heater 18 and 24 may receive power from the power supply 11 to heat the aerosol-generating article (e.g., a cigarette) and/or a medium and/or an aerosol-generating substance in the cartridge. The aerosol-generating device 1 may include a heater 18 for heating the aerosol-generating article and/or a cartridge heater 24 for heating the cartridge (i.e., a solid and/or liquid medium).

According to one embodiment, the heater 18 and 24 may be an electro-resistive heater. For example, the electro-resistive heater may include an electrically resistive material such as a metal or a metal alloy including titanium, zirconium, tantalum, platinum, nickel, cobalt, chromium, hafnium, niobium, molybdenum, tungsten, tin, gallium, manganese, iron, copper, stainless steel, and nichrome. The electro-resistive heater may be implemented as a metal wire, a metal plate having an electrically conductive track disposed thereon, or a ceramic heating element.

According to one embodiment, the heater 18 and 24 may be an induction heater. For example, the induction heater may include a susceptor that generates heat through a magnetic field. A magnetic field may be generated by an induction coil by alternating current flowing through the induction coil. The magnetic field may pass through the heater, and an eddy current may be generated in the susceptor. The susceptor may be heated based on generation of the eddy current. According to one embodiment, the susceptor may be included in the inner portion (e.g., the medium portion) of the aerosol-generating article. In this case, the susceptor included in the inner portion of the aerosol-generating article may also be heated by the induction coil.

The heater 18 and 24 is not limited to the examples described above, and may include or be replaced with various heating methods, structures, and components for heating the aerosol-generating article and/or the cartridge.

According to one embodiment, the input unit 15 may receive information input from the user. For example, the input unit 15 may include a touch panel, a button, a keypad, a dome switch, a jog wheel, and a jog switch.

According to one embodiment, the memory 17 may be hardware storing various pieces of data processed in the aerosol-generating device 1. The memory 17 may store data processed and to be processed by the controller 12. For example, the memory 17 may include at least one type of storage medium among a flash memory type memory, a hard disk type memory, a multimedia card micro type memory, a card type memory (e.g., SD or XD memory), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disc. For example, the memory 17 may store data on an operation time of the aerosol-generating device 1, the maximum number of puffs, the current number of puffs, at least one temperature profile, and the user's smoking pattern.

According to one embodiment, the communication unit 16 may include at least one component for communication with other electronic devices (e.g., a portable electronic device). For example, the communication unit 16 may include a Bluetooth communication unit, a Bluetooth low energy (BLE) communication unit, a near-field communication unit, a wireless local area network (WLAN) communication unit, a Zigbee communication unit, an infrared data association (IrDA) communication unit, a Wi-Fi direct (WFD) communication unit, an ultra-wideband (UWB) communication unit, an Ant+ communication unit, a cellular network communication unit, an Internet communication unit, and a computer network (e.g., LAN or WAN) communication unit.

According to one embodiment, the controller 12 may control the overall operation of the aerosol-generating device 1. For example, the controller 12 may include at least one processor. The controller 12 may be implemented as an array of a plurality of logic gates or may be implemented as a combination of a general-purpose microcontroller unit (MCU) (or a microprocessor) and a memory in which a program executable by the MCU is stored. It will be understood by those skilled in the art that the controller may also be implemented as other forms of hardware.

According to one embodiment, the controller 12 may control the supply of power from the power supply 11 to the heater 18 and 24 to control the temperature of the heater 18 and 24. The controller 12 may control the temperature of the heater 18 and 24 and/or power supplied to the heater 18 and 24 based on the temperature of the heater 18 and 24 detected by the temperature sensor (e.g., the sensor unit 13). The controller 12 may control the temperature of the heater 18 and 24 and/or power supplied to the heater 18 and 24 based on the temperature profile and/or the power profile stored in the memory 17.

According to one embodiment, the controller 12 may control a power conversion circuit (not shown) electrically connected to the heater 18 and 24 and the power supply 11 to control power (e.g., voltage and/or current) supplied to the heater 18 and 24. For example, the power conversion circuit may include a DC/DC converter (e.g., a buck converter, a buck-boost converter, a boost converter, or a Zener diode) that converts power to be supplied to the heater 18 and 24 and a DC/AC converter (e.g., an inverter) that converts power to be supplied to the induction coil (not shown). The DC/AC converter may be implemented as a full-bridge circuit or a half-bridge circuit including a plurality of switching elements. For example, the power conversion circuit may include at least one switching element, such as a bipolar junction transistor (BJT) or a field effect transistor (FET).

According to one embodiment, the controller 12 may control the frequency and/or duty ratio of a current pulse input to at least one switching element of the power conversion circuit (not shown) to control the current and/or the voltage supplied to the heater 18 and 24. The duty ratio for the on/off operation of the switching element may correspond to a ratio of the voltage output from the power conversion circuit to the voltage output from the power supply 11.

According to one embodiment, the controller 12 may control power supplied to the heater 18 and 24 using at least one of a pulse width modulation (PWM) scheme or a proportional-integral-differential (PID) scheme. For example, the controller 12 may perform control using the PWM scheme such that a current pulse having a predetermined frequency and a predetermined duty ratio is supplied to the heater 18 and 24. The controller 12 may control the frequency and duty ratio of the current pulse to control power supplied to the heater 18 and 24. For example, the controller 12 may determine, based on the temperature profile, a target temperature to be controlled. The controller 12 may control power supplied to the heater 18 and 24 using the PID scheme, which is a feedback control scheme using a difference value between the temperature of the heater 18 and the target temperature, a value obtained by integrating the difference value with respect to time, and a value obtained by differentiating the difference value with respect to time.

According to one embodiment, the controller 12 may determine, based on the power profile, target power to be controlled. The controller 12 may control power supplied to the heater 18 and 24 so as to correspond to the preset target power over time.

According to one embodiment, the controller 12 may detect power supplied to the heater 18 and 24 to determine the user's puff. In more detail, the controller 12 may control power supplied to the heater 18 and 24 using the proportional-integral-differential (PID) scheme. When the user's puff occurs, temperature drop may temporarily occur in a space into which the aerosol-generating article is inserted (hereinafter referred to as an insertion space) and the heater 18 and 24. Accordingly, the power (or the current) supplied to the heater 18 and 24 may change during control of the power using the PID scheme. The controller 12 may determine the user's puff based on the change in the power controlled.

According to one embodiment, the controller 12 may prevent the heater 18 and 24 from overheating. For example, the controller 12 may control, based on the temperature of the heater 18 and 24 exceeding a preset limit temperature, operation of the power conversion circuit such that the amount of power supplied to the heater 18 and 24 is reduced or the supply of power to the heater 18 and 24 is interrupted.

According to one embodiment, the controller 12 may control charging/discharging of the power supply 11. For example, the controller 12 may check the temperature of the power supply 11 using the temperature sensor (e.g., the sensor unit 13). If the temperature of the power supply 11 is equal to or higher than a first limit temperature, the controller 12 may interrupt charging of the power supply 11. If the temperature of the power supply 11 is equal to or higher than a second limit temperature, the controller 12 may interrupt use of the power stored in the power supply 11 (e.g., discharging). The controller 12 may calculate the remaining amount of the power stored in the power supply 11. For example, the controller 12 may calculate the remaining capacity of the power supply 11 based on a voltage and/or current detection value of the power supply 11.

According to one embodiment, the controller 12 may control the supply of power to the heater 18 and 24 based on a result of the detection by the sensor unit 13.

According to one embodiment, the controller 12 may control the supply of power to the heater 18 and 24 based on insertion and/or removal of the aerosol-generating article into and/or from the insertion space. For example, upon determining that the aerosol-generating article has been inserted into the insertion space using the insertion detection sensor (e.g., the sensor unit 13), the controller 12 may perform control such that power is supplied to the heater 18 and 24. Upon determining that the aerosol-generating article has been removed from the insertion space using the insertion detection sensor (e.g., the sensor unit 13), the controller 12 may interrupt the supply of power to the heater 18 and 24. The controller 12 may determine that the aerosol-generating article has been removed from the insertion space when the temperature of the heater 18 and 24 is equal to or higher than a limit temperature or when the temperature change slope of the heater 18 and 24 is equal to or greater than a preset slope.

According to one embodiment, the controller 12 may control, based on the state of the aerosol-generating article, a power supply time and/or the amount of power supplied to the heater 18 and 24. For example, upon determining that the aerosol-generating article is in an overly moist state using the overly moist state detection sensor (e.g., the sensor unit 13), the controller 12 may increase a time during which power is supplied to the heater 18 and 24 (e.g., a preheating time).

According to one embodiment, the controller 12 may control the supply of power to the heater 18 and 24 based on whether the aerosol-generating article is being reused. For example, upon determining that the aerosol-generating article has already been used, the controller 12 may interrupt the supply of power to the heater 18 and 24.

According to one embodiment, the controller 12 may control the supply of power to the heater 18 and 24 based on whether the cartridge has been coupled and/or removed. For example, upon determining that the cartridge has been removed using the cartridge detection sensor (e.g., the sensor unit 13), the controller 12 may interrupt the supply of power to the heater 18 or 24 or may perform control such that power is not supplied to the heater 18 and 24.

According to one embodiment, the controller 12 may control the supply of power to the heater 18 and 24 based on whether the aerosol-generating substance in the cartridge has been exhausted. For example, upon determining that the temperature of the heater 18 and 24 exceeds a limit temperature during preheating of the heater 18 and 24 (i.e., in the preheating section), the controller 12 may determine that the aerosol-generating substance in the cartridge has been exhausted. Upon determining that the aerosol-generating substance in the cartridge has been exhausted, the controller 12 may interrupt the supply of power to the heater 18 and 24.

According to one embodiment, the controller 12 may control the supply of power to the heater 18 and 24 based on whether use of the cartridge is possible. For example, upon determining, based on data stored in the memory 17, that the current number of puffs is equal to or greater than the maximum number of puffs set for the cartridge, the controller 12 may determine that use of the cartridge is impossible. Alternatively, when a total time period during which the heater 18 and 24 is heated is equal to or longer than a preset maximum time period or when the total amount of power supplied to the heater 18 and 24 is equal to or greater than a preset maximum amount of power, the controller 12 may determine that use of the cartridge is impossible. In this case, the controller 12 may interrupt the supply of power to the heater 18 or 24 or may perform control such that power is not supplied to the heater 18 and 24.

According to one embodiment, the controller 12 may control the supply of power to the heater 18 and 24 based on the user's puff. For example, the controller 12 may determine whether a puff occurs and/or the intensity of a puff using the puff sensor (e.g., the sensor unit 13). When the number of puffs reaches a preset maximum number of puffs and/or when no puff is detected for a preset time period or longer, the controller 12 may interrupt the supply of power to the heater 18 and 24. When a puff is detected, the controller 12 may control the supply of power to the heater 18 and 24.

According to one embodiment, the controller 12 may control the supply of power to the heater 18 and 24 based on whether the aerosol-generating article (or the cartridge) is authentic and/or the type of the aerosol-generating article (or the cartridge). For example, the controller 12 may determine whether the aerosol-generating article is authentic and/or may determine the type of the aerosol-generating article using the cigarette identification sensor (e.g., the sensor unit 13). In an example, upon determining that the aerosol-generating article (or the cartridge) is inauthentic, the controller 12 may interrupt the supply of power to the heater 18 and 24. Upon determining that the aerosol-generating article (or the cartridge) is authentic, the controller 12 may control (e.g., commence) the supply of power to the heater 18 and 24. In another example, the controller 12 may control the supply of power to the heater 18 and 24 differently depending on the type of the aerosol-generating article (or the cartridge). In more detail, upon determining that the aerosol-generating article (or the cartridge) is a first aerosol-generating article (or a first cartridge), the controller 12 may control the temperature of the heater 18 and 24 and/or power based on a first temperature profile (or a first power profile), and upon determining that the aerosol-generating article (or the cartridge) is a second aerosol-generating article (or a second cartridge), the controller 12 may control the temperature of the heater 18 and 24 and/or power based on a second temperature profile (or a second power profile).

According to one embodiment, the controller 12 may control the output unit 14 based on a result of detection by the sensor unit 13. For example, when the number of puffs counted using the puff sensor (e.g., the sensor unit 13) reaches a preset number, the controller 12 may control the output unit 14 to visually, haptically, and/or audibly provide information that operation of the aerosol-generating device 1 will end soon. For example, the controller 12 may control the output unit 14 to visually, haptically, and/or audibly provide information about the temperature of the heater 18 and 24.

According to one embodiment, based on occurrence of a predetermined event, the controller 12 may store a history of the corresponding event in the memory 17 and may update the history. For example, the event may include events performed in the aerosol-generating device 1, such as detection of insertion of the aerosol-generating article, commencement of heating of the aerosol-generating article, detection of puff, termination of puff, detection of overheating of the heater 18 and 24, detection of application of overvoltage to the heater 18 and 24, termination of heating of the aerosol-generating article, on/off operation of the aerosol-generating device 1, commencement of charging of the power supply 11, detection of overcharging of the power supply 11, and termination of charging of the power supply 11. For example, the history of the event may include the occurrence date and time of the event and log data corresponding to the event. For example, when the predetermined event is detection of insertion of the aerosol-generating article, the log data corresponding to the event may include data on a value detected by the insertion detection sensor (e.g., the sensor unit 13). For example, when the predetermined event is detection of overheating of the heater 18 and 24, the log data corresponding to the event may include data on the temperature of the heater 18 and 24, the voltage applied to the heater 18 and 24, and the current flowing through the heater 18 and 24.

According to one embodiment, the controller 12 may control the communication unit 16 to form a communication link with an external device such as a user's mobile terminal.

According to one embodiment, upon receiving data on authentication from an external device via the communication link, the controller 12 may release restriction on use of at least one function (e.g., a heating function) of the aerosol-generating device 1. For example, the data on authentication may include the user's birthday, an identification number uniquely identifying the user, and whether authentication is completed by the user.

According to one embodiment, the controller 12 may transmit data on the state of the aerosol-generating device 1 (e.g., remaining capacity of the power supply 11 and operation mode) to the external device via the communication link. The transmitted data may be output through a display or the like of the external device.

According to one embodiment, upon receiving a request to search for the location of the aerosol-generating device 1 from the external device via the communication link, the controller 12 may control the output unit 14 to perform an operation corresponding to location search. For example, the controller 12 may perform control such that the haptic unit generates vibration or the display outputs objects corresponding to location search and termination of search.

According to one embodiment, upon receiving firmware data from the external device via the communication link, the controller 12 may perform firmware update.

According to one embodiment, the controller 12 may transmit data on a value detected by the at least one sensor unit 13 to an external server (not shown) via the communication link, and may receive, from the server, and store a learning model generated by learning the detected value through machine learning such as deep learning. The controller 12 may perform the operation of determining the user's puff pattern and the operation of generating the temperature profile using the learning model received from the server.

Although not shown in FIG. 1, the aerosol-generating device 1 may further include a power supply protection circuit. The power supply protection circuit may include at least one switching element, and may block an electric path to the power supply 11 in response to overcharging and/or overdischarging of the power supply 11. The aerosol-generating device 1 may further include a connection interface such as a universal serial bus (USB) interface, and may be connected to other external devices through the connection interface to transmit and receive information or charge the power supply 11.

The aerosol-generating article mentioned in the present disclosure may include at least one aerosol-generating rod (e.g., a medium portion) and at least one filter rod. The heater 18 may be disposed to correspond to the at least one aerosol-generating rod, and may be designed differently depending on the arrangement order and/or positions of the aerosol-generating rod and the filter rod. The aerosol-generating rod may contain at least one of nicotine, an aerosol-generating substance, and an additive. For example, the aerosol-generating substance may include glycerin (e.g., vegetable glycerin (VG)) and/or propylene glycol (PG) and may also include various other substances. For example, the additive may include a flavoring agent and/or an organic acid and may also include various other substances. For example, the aerosol-generating rod may include an aerosol-generating substrate (e.g., a sheet) impregnated with a liquid non-tobacco substance (e.g., an aerosol-generating substance and/or nicotine) and/or may contain a solid tobacco substance (e.g., leaf tobacco and reconstituted tobacco). The tobacco substance may be contained in the aerosol-generating rod in various forms, such as shredded tobacco, granules, and powder. According to one embodiment, the additive of the aerosol-generating rod may include an alkaline substance. Based on the alkaline substance, nicotine contained in the tobacco substance in the aerosol-generating rod may have an alkaline pH (e.g., pH 7.0 or higher). In this case, freebase nicotine may be released from the aerosol-generating rod even at a low temperature. According to one embodiment, the aerosol-generating rod may include two or more aerosol-generating rods, each of which may contain a tobacco substance and/or a non-tobacco substance. Meanwhile, although not shown, the at least one aerosol-generating rod and the at least one filter rod may individually and/or integrally be wrapped by at least one wrapper. In the present disclosure, the aerosol-generating article may be referred to as a stick.

The cartridge mentioned in the present disclosure may contain an aerosol-generating substance having any one state among a liquid state, a solid state, a gaseous state, and a gel state. The aerosol-generating substance may include a liquid composition. For example, the liquid composition may be a liquid containing a tobacco-containing substance including a volatile tobacco flavor component or may be a liquid containing a non-tobacco substance. Meanwhile, the cartridge may include a storage part that contains the aerosol-generating substance and/or a liquid delivery part that is impregnated with (contains) the aerosol-generating substance. For example, the liquid delivery part may include a wick formed of, e.g., cotton fiber, ceramic fiber, glass fiber, or porous ceramic. The cartridge heater 24 may be included in the cartridge in a coil-shaped structure surrounding (or wound around) the liquid delivery part or a structure contacting one side of the liquid delivery part. Alternatively, the cartridge heater 24 may be included in the aerosol-generating device 1, which is removable from the cartridge.

Certain embodiments or other embodiments of the disclosure described above are not mutually exclusive or distinct from each other. Any or all elements of the embodiments of the disclosure described above may be combined with another or combined with each other in configuration or function.

For example, a configuration “A” described in one embodiment of the disclosure and the drawings and a configuration “B” described in another embodiment of the disclosure and the drawings may be combined with each other. Namely, although the combination between the configurations is not directly described, the combination is possible except in the case where it is described that the combination is impossible.

Although embodiments have been described with reference to a number of illustrative embodiments thereof, it should be understood that numerous other modifications and embodiments can be devised by those skilled in the art that will fall within the scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

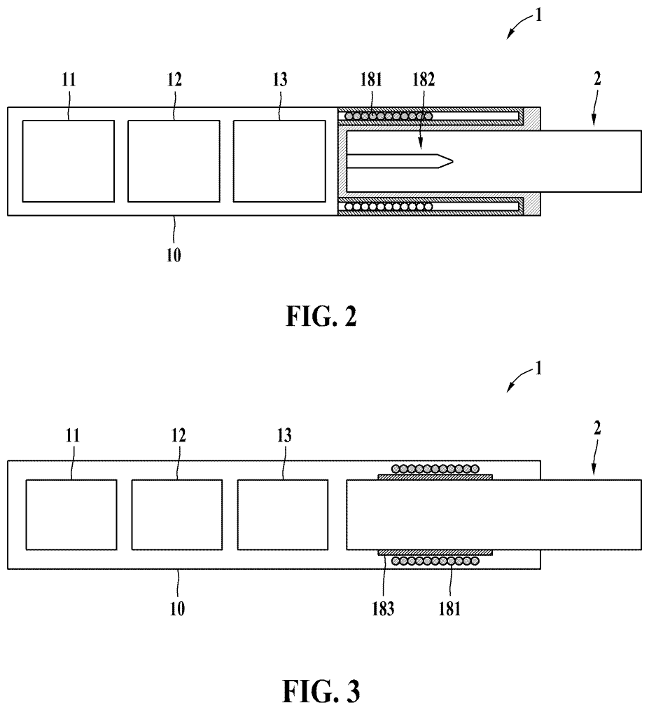

FIG. 2 shows an aerosol-generating device 1 according to one embodiment. FIG. 3 shows an aerosol-generating device 1 according to one embodiment.

According to one embodiment, the aerosol-generating device 1 may include a housing 10, a power supply 11, a controller 12, a sensor unit 13, and/or a heater 182 and 183 (e.g., the heater 18 in FIG. 1). However, it will be understood by those skilled in the art related to the present embodiment that the components included in the aerosol-generating device 1 are not limited to those shown in FIG. 2 or FIG. 3 and that some of the components may be omitted or new components may be further included. The aerosol-generating device 1 shown in FIG. 2 may be referred to as an “internal heating-type” aerosol-generating device that heats the inner side of an aerosol-generating article 2. The aerosol-generating device 1 shown in FIG. 3 may be referred to as an “external heating-type” aerosol-generating device that heats the outer side of the aerosol-generating article 2. In the drawings below, a description of configurations identical to those shown in FIG. 1 will be omitted.

According to one embodiment, the housing 10 may provide a space that is open upwardly to allow the aerosol-generating article 2 to be inserted thereinto. In the present disclosure, the space that is open upwardly may be referred to as an insertion space. The insertion space may be formed so as to be depressed in the housing 10 to a predetermined depth so that at least a portion of the aerosol-generating article 2 may be inserted thereinto. The depth of the insertion space may be equal to or greater than the length of a region of the aerosol-generating article 2 in which an aerosol-generating substance and/or a medium is contained. The lower end of the aerosol-generating article 2 may be inserted into the housing 10, and the upper end of the aerosol-generating article 2 may protrude outside the housing 10. A user may inhale an aerosol while holding the externally exposed upper end of the aerosol-generating article 2 in the mouth.

According to one embodiment, the heater 182 and 183 may heat the aerosol-generating article 2.

Referring to FIG. 2, the heater 182 may be an internal heating-type heater.

According to one embodiment, the internal heating-type heater may be elongated upwardly in the space into which the aerosol-generating article 2 is inserted (i.e., the insertion space). For example, as shown in the drawings, the internal heating-type heater may include a rod-shaped or needle-shaped heating element. Alternatively, the internal heating-type heater may include various other heating elements, such as a tubular heating element or a plate-shaped heating element. The internal heating-type heater may be inserted through the lower portion of the aerosol-generating article 2.

According to one embodiment, the internal heating-type heater may include an electro-resistive heater and/or an induction heater.

For example, the electro-resistive heater may include an electro-resistive material, which is provided on the inner side (e.g., in the cavity or on the inner surface) or outer side (e.g., on the outer surface) thereof, and may generate heat as current flows through the electro-resistive material. In this case, the electro-resistive heater may be electrically connected to the power supply 11, and may directly generate heat using current received from the power supply 11. Meanwhile, an induction coil 181 may be omitted.

For example, in the case of an induction heater, the aerosol-generating device 1 may include an induction coil 181 surrounding at least a portion of the internal heating-type heater (e.g., disposed outside the heater so as to correspond to the length of at least a portion of the heater). In this case, a magnetic flux concentrator may be further provided outside the induction coil 181 in order to increase efficiency of induction heating. The induction heater may include a susceptor, and may generate heat based on a magnetic field generated by the induction coil 181. According to one embodiment, the induction heater (e.g., the susceptor) (or a heater module including the same) may be disposed to be removable from the housing 10.

According to one embodiment, the heater 182 may be a multi-heater. The multi-heater may include a first heater and a second heater, and may be inserted into the aerosol-generating article 2. The first heater and the second heater may be disposed side by side in the longitudinal direction. The first heater and the second heater may operate as an electro-resistive heater and/or an induction heater, and may be heated sequentially or simultaneously. In this case, the first heater and the second heater may be disposed at positions corresponding to the positions of two or more aerosol-generating rods in the longitudinal direction, respectively. Alternatively, the first heater and the second heater may be disposed at positions corresponding to the positions of a first portion and a second portion of one aerosol-generating rod in the longitudinal direction, respectively. Meanwhile, if the heater 182 is an induction heater, the aerosol-generating device 1 may include a first induction coil and a second induction coil, and the first induction coil and the second induction coil may be disposed at positions corresponding to the positions of the first heater and the second heater in the longitudinal direction, respectively. Alternatively, the first heater and the second heater may be disposed at positions corresponding to the positions of a first portion and a second portion of one heater 182 in the longitudinal direction, respectively. In addition, three or more heaters and/or three or more induction coils may be included.

According to one embodiment, the susceptor may be disposed on (or included in) the inner side (e.g., the medium portion) of the aerosol-generating article 2. The susceptor included inside the aerosol-generating article 2 may be implemented to be heated based on a magnetic field generated by the induction coil 181.

Referring to FIG. 3, the heater 183 may be an external heating-type heater.

According to one embodiment, the external heating-type heater may be elongated upwardly around the space into which the aerosol-generating article 2 is inserted (i.e., the insertion space). For example, the external heating-type heater may be disposed so as to surround at least a portion of the insertion space. In an example, the external heating-type heater may include a tube shape (e.g., a cylindrical shape) with a cavity formed therein. The external heating-type heater may alternatively include a shape including a cavity formed therein and surrounding the cavity. In this case, the external heating-type heater may be supported by a polyimide film. The heater supported by this film may be referred to as a film heater. The external heating-type heater may be disposed so as to surround at least a portion of the insertion space. The external heating-type heater may heat the outer side of the aerosol-generating article 2 inserted into the cavity.

According to one embodiment, the external heating-type heater may include an electro-resistive heater and/or an induction heater, and a description of configurations identical to those shown in FIG. 2 will be omitted. Meanwhile, in the case of an induction heater, the aerosol-generating device 1 may include an external heating-type heater implemented as a tubular susceptor and may include an induction coil 181 surrounding at least a portion of the external heating-type heater (e.g., disposed outside the heater so as to correspond to the length of at least a portion of the heater). In addition, the induction coil 181 may include a fan coil. Meanwhile, if the external heating-type heater is an electro-resistive heater, heat may be generated through current flow through the tubular electro-resistive heater (e.g., the film heater), and thus a separate induction coil 181 may be omitted. Meanwhile, a thermally insulating material may be disposed outside the external heating-type heater. Accordingly, the amount of heat emitted from the heater 183 in the radially outward direction and released outside the housing 10 may be reduced.

According to one embodiment, the heater 183 may be a multi-heater, and the first heater and the second heater may be disposed side by side in the longitudinal direction so as to surround at least a portion of the insertion space. The first heater and the second heater may operate as an electro-resistive heater and/or an induction heater, and may be heated sequentially or simultaneously. Meanwhile, if the heater 183 is an induction heater, the aerosol-generating device 1 may include a first induction coil and a second induction coil. The first induction coil and the second induction coil may be disposed at positions corresponding to the positions of the first heater and the second heater in the longitudinal direction, respectively. Alternatively, the first heater and the second heater may be disposed at positions corresponding to the positions of a first portion and a second portion of one heater 183 in the longitudinal direction, respectively.

Unlike the configuration shown in FIG. 2 or FIG. 3, both the heater 182 in FIG. 2 and the heater 183 in FIG. 3 may be included in the aerosol-generating device 1. In this case, the heater 182 may heat the inner side of the aerosol-generating article 2, and the heater 183 may heat the outer side of the aerosol-generating article 2.

According to one embodiment, the aerosol-generating device 1 may be provided with an airflow channel through which air flows. For example, the housing 10 may include a structure (e.g., a hole) through which outside air may be introduced into the housing 10. The air introduced into the housing 10 may be introduced into the aerosol-generating article 2 through the lower end (i.e., upstream side) of the aerosol-generating article 2. An aerosol generated based on heating of the aerosol-generating article 2 may be inhaled into the user's oral cavity together with the introduced air through the upper end (i.e., downstream side) of the aerosol-generating article 2.

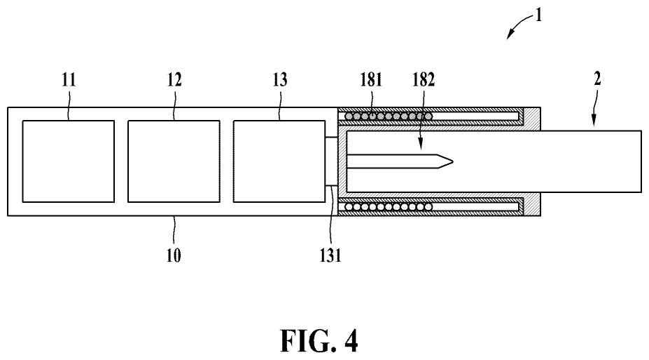

FIG. 4 shows an aerosol-generating device 1 according to one embodiment.

According to one embodiment, the aerosol-generating device 1 may further include a temperature sensor 131. The temperature sensor 131 may be disposed within a body (e.g., the housing 10) of the aerosol-generating device 1 to measure a temperature. For example, the temperature sensor 131 may be disposed on a lower side of the heater 182 as illustrated, and may be disposed on a lower side of a rod-shaped or needle-shaped heating element included in the heater 182. For example, the controller 12 may obtain information on a rise or fall of a temperature inside the body and a temperature of the heater 182 due to an external environment or an operation of the aerosol-generating device 1 through the temperature sensor 131.

For example, the temperature sensor 131 may be a negative temperature coefficient (NTC) temperature sensor. The controller 12 may determine a temperature model of the heater 182 based on a temperature sensed by the temperature sensor 131.

According to one embodiment, the heater (182) may be an induction heating type heater, and the induction heating type heater 182 (e.g., susceptor) (or heater module including the same) may be disposed to be detachable from the housing 10. For example, the temperature sensor 131 may be disposed to measure a temperature around the heater 182. Even when the heater 182 is separated from the housing 10, the temperature sensor 131 may not be separated from the housing 10.

Unlike as shown in FIG. 4, the heater 182 may be an external heating type heater capable of heating the outside of the aerosol-generating article 2 inserted into a hollow, and the heater 182 may be disposed to be detachable from the housing 10. For example, the temperature sensor 131 may be disposed to measure a temperature around the heater 182.

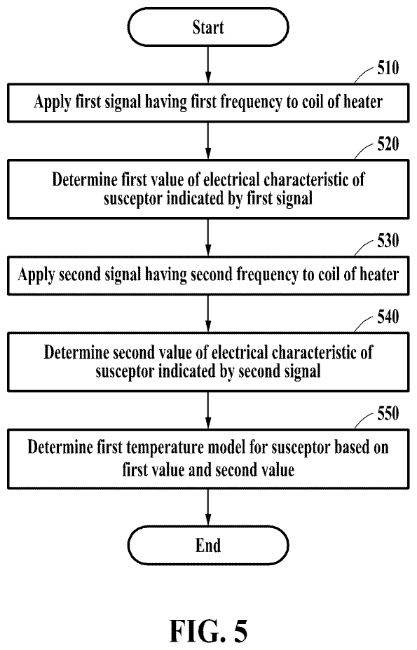

FIG. 5 is a flowchart of a method of determining a temperature model of a susceptor, according to one embodiment.

The following operations 510 to 550 may be performed by an aerosol-generating device (e.g., the aerosol-generating device 1 of FIGS. 1 to 4). The aerosol-generating device may include a susceptor (e.g., the heater 18 of FIG. 1, the heater 182 of FIGS. 2 and 4, or the heater 183 of FIG. 3), a sensor unit (e.g., the sensor unit 13 of FIGS. 1 to 4), and a controller (e.g., the controller 12 of FIGS. 1 to 4).

According to one embodiment, the aerosol-generating device may determine a temperature model of a susceptor based on electrical characteristics of the susceptor that appear in response to an alternating magnetic field having a first frequency and an alternating magnetic field having a second frequency, respectively, in a temperature model determination mode. For example, the temperature model determination mode may be a mode for determining a temperature model corresponding to the susceptor. For example, the aerosol-generating device may calculate a temperature of the susceptor based on the electrical characteristics and temperature model of the susceptor, and control an operation of the aerosol-generating device based on the calculated temperature of the susceptor. For example, the controller may perform heating of an aerosol-generating article for optimal smoking by controlling a signal applied to a coil of the heater so that the temperature of the susceptor corresponds to a preset temperature profile (e.g., a first temperature profile) based on the calculated temperature of the susceptor.

In operation 510, the aerosol-generating device may apply a first signal having a first frequency to a coil of the heater so that an alternating magnetic field is generated. The first signal may have a preset current, voltage, and duty ratio. The first frequency may be a frequency of a signal applied to a coil of the heater in a mode in which the aerosol-generating device measures the temperature of the susceptor. For example, the first frequency may be 290 kHz.

According to one embodiment, the susceptor of the aerosol-generating device may be disposed to be detachable, and the aerosol-generating device may perform operation 510 when it is determined that the disposed susceptor has changed. For example, when a user input corresponding to the change of the susceptor is received, the aerosol-generating device may perform operation 510. For example, when an input is received that a susceptor is newly mounted, the aerosol-generating device may perform operation 510.

According to one embodiment, an operation of applying the first signal to the coil may be performed for a short time (e.g., several milliseconds) so that the temperature of the susceptor does not increase due to eddy currents induced in the susceptor by the first signal.

According to one embodiment, a voltage of the first signal may be less than or equal to a preset voltage so that the temperature of the susceptor does not increase due to eddy currents induced in the susceptor by the first signal.

According to one embodiment, the susceptor may not be electrically connected to the aerosol-generating device. Although no electricity flows from the aerosol-generating device to the susceptor, an alternating magnetic field generated by the aerosol-generating device and the coil of the aerosol-generating device may cause electromagnetic induction in the susceptor, causing eddy currents to flow in the susceptor.

According to one embodiment, when an aerosol-generating article is inserted into the aerosol-generating device, the susceptor may be disposed inside the aerosol-generating article. For example, the susceptor may be a tubular heating element, a plate-shaped heating element, a needle-shaped heating element, or a rod-shaped heating element.

According to one embodiment, the susceptor may be included in an aerosol-generating article inserted into the aerosol-generating device. For example, the susceptor may be included in a filter paper of the aerosol-generating article. For example, the susceptor may be included within a tobacco rod of the aerosol-generating article.

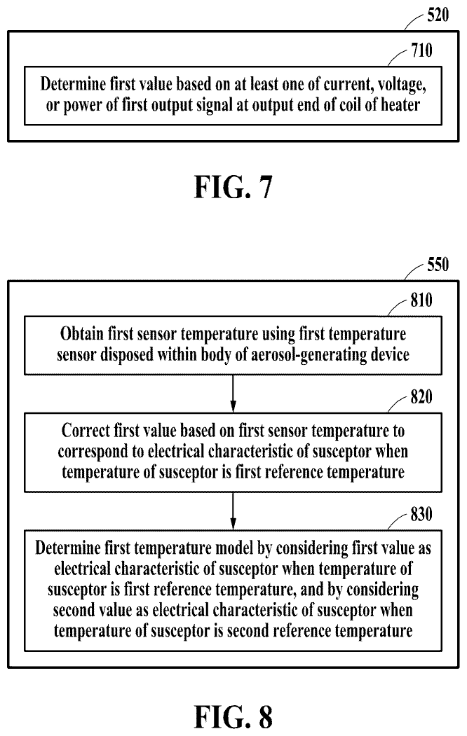

In operation 520, the aerosol-generating device may determine a first value of an electrical characteristic of the susceptor indicated by a first signal. The operation of determining the first value is described in detail below with reference to FIG. 7.

According to one embodiment, the aerosol-generating device may further include a detection circuit for determining a first value of the electrical characteristic of the susceptor indicated by a first signal at an output end of the coil of the heater. The detection circuit may not be electrically connected to the susceptor.

In operation 530, the aerosol-generating device may apply a second signal having a second frequency to the coil of the heater so that an alternating magnetic field is generated. The second signal may have a preset current, voltage, and duty ratio. For example, the second frequency may be 303 kHz.

According to one embodiment, the electrical characteristic appearing in the susceptor at a first reference temperature (e.g., 25° C.) by the second signal may correspond to the electrical characteristic appearing in the susceptor at a second reference temperature by the first signal. For example, a magnitude of an eddy current generated in the susceptor at 25° C. when the second signal is applied to the coil of the heater may be the same as a magnitude of an eddy current generated in the susceptor at 300° C. when the first signal is applied to the coil of the heater.

According to one embodiment, an operation of applying the second signal to the coil may be performed for a short time (e.g., several milliseconds) so that the temperature of the susceptor does not increase due to eddy currents induced in the susceptor by the second signal. According to one embodiment, a voltage of the second signal may be less than a preset voltage so that the temperature of the susceptor does not increase due to eddy currents induced in the susceptor by the second signal.

In operation 540, the aerosol-generating device may determine a second value of the electrical characteristic of the susceptor indicated by the second signal. The description of operation 520 may be similarly applied to operation 540 with modifications.

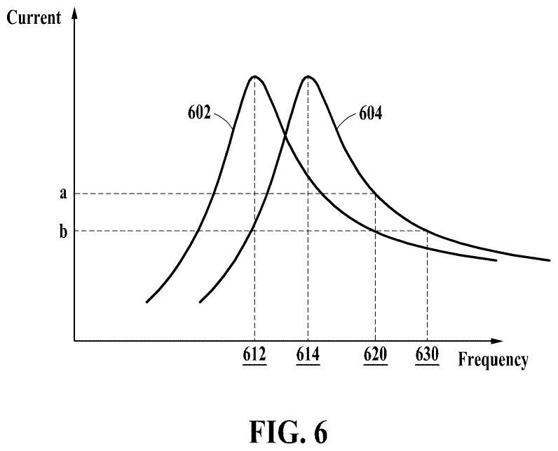

In operation 550, the aerosol-generating device may determine a first temperature model for the susceptor based on the first value and the second value. A method of determining a temperature model for the susceptor is described in detail below with reference to FIGS. 6 to 9.

FIG. 6 shows trajectories of eddy currents in a susceptor as indicated by a frequency of a signal, according to one embodiment.

According to one embodiment, since a first natural frequency 614 of a susceptor (e.g., the heater 18 of FIG. 1, the heater 182 of FIGS. 2 and 4, or the heater 183 of FIG. 3) at a first reference temperature (e.g., 25° C.) and a second natural frequency 612 of the susceptor at a second reference temperature (e.g., 300° C.) are different from each other, a first eddy current trajectory 604 of the susceptor at the first reference temperature and a second eddy current trajectory 602 of the susceptor at the second reference temperature, which are indicated by a frequency of a given signal, may be different. For example, as a temperature of the susceptor increases, electrical characteristics of the susceptor, such as natural frequency and impedance, may change. When an aerosol-generating device (e.g., the aerosol-generating device 1 of FIGS. 1 to 4) performs a frequency sweep for an entire frequency band, the first eddy current trajectory 604 of the susceptor may be generated at the first reference temperature and the second eddy current trajectory 602 of the susceptor may be generated at the second reference temperature.

According to one embodiment, the susceptor may exhibit different electrical characteristics for the same signal depending on the temperature. For example, when a first signal having a first frequency 620 is applied to the susceptor, the susceptor at the first reference temperature may generate an eddy current of a first value a, while the susceptor at the second reference temperature may generate an eddy current of a second value b.

According to one embodiment, a magnitude of an eddy current appearing in the susceptor at the first reference temperature by a second signal having a second frequency 630 may correspond to a magnitude of an eddy current appearing in the susceptor at the second reference temperature by a first signal having the first frequency 620. For example, the first frequency 620 may be 290 kHz, and the second frequency 630 may be 303 kHz. For example, a magnitude of an eddy current occurring in the susceptor at the first reference temperature when the second signal is applied to a coil of a heater may be the second value b, which may be equal to a magnitude of an eddy current occurring in the susceptor at the second reference temperature when the first signal is applied to the coil of the heater.

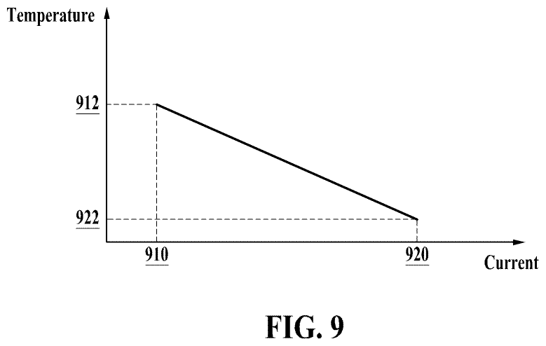

According to one embodiment, the aerosol-generating device may estimate a temperature of the susceptor based on a magnitude of an eddy current appearing in the susceptor by the first signal. For example, the magnitude of the eddy current appearing in the susceptor by the first signal and the temperature of the susceptor may exhibit a linear relationship in an interval between the first reference temperature and the second reference temperature. For example, the aerosol-generating device may determine a temperature model of the susceptor based on the linear relationship. An operation of determining the temperature model of the susceptor is described in detail below with reference to FIGS. 8 and 9.

According to one embodiment, a magnitude of an eddy current of the susceptor indicated by a signal frequency may be indirectly obtained from a detection circuit connected to an output end of the coil of the heater. Since at least a portion of electric energy of the signal applied to the coil of the heater is absorbed by the susceptor to generate an eddy current, the detection circuit may indirectly obtain the magnitude of the eddy current of the susceptor by comparing a current, voltage or power of the signal applied to the coil of the heater with a current, voltage or power of an output signal. When the eddy current of the susceptor is indirectly obtained through the detection circuit, since the susceptor is not electrically connected to other components of the aerosol-generating device, the susceptor of the aerosol-generating device may be easily replaced.

FIG. 7 is a flowchart of a method of determining an electrical characteristic of a susceptor, according to one embodiment.

The following operation 710 may be performed by an aerosol-generating device (e.g., the aerosol-generating device 1 of FIGS. 1 to 4). The aerosol-generating device may include a susceptor (e.g., the heater 18 of FIG. 1, the heater 182 of FIGS. 2 and 4, or the heater 183 of FIG. 3), a sensor unit (e.g., the sensor unit 13 of FIGS. 1 to 4), and a controller (e.g., the controller 12 of FIGS. 1 to 4). For example, operation 520 described with reference to FIG. 5 above may include operation 710.

In operation 710, the aerosol-generating device may determine a first value based on at least one of a current, voltage, or power of a first output signal at an output end of a coil of a heater. For example, the aerosol-generating device may further include a detection circuit for determining a first value of the electrical characteristic of the susceptor indicated by the first signal at an output end of the coil of the heater. The detection circuit may not be electrically connected to the susceptor.

For example, the electrical characteristic may be at least one of a current, voltage, or power of the first output signal at the output end of the coil of the heater. For example, the electrical characteristic may be a characteristic determined based on at least one of a current, voltage, or power of the first output signal at the output terminal of the coil of the heater. For example, the electrical characteristic may be an eddy current occurring in the susceptor. For example, the electrical characteristic may be an impedance of the susceptor. As an alternating magnetic field generated in the coil of the heater generates an eddy current in the susceptor, a portion of the electrical energy of the first signal may be transferred to the susceptor, and the current, voltage, or power of the first signal may be different from the current, voltage, or power of the first output signal.

According to one embodiment, the aerosol-generating device may determine the second value in operation 540 described above with reference to FIG. 5 by using the manner in which the first value is determined in operation 710.

FIG. 8 is a flowchart of a method of determining a temperature model of a susceptor based on a temperature of a sensor, according to one embodiment, and FIG. 9 shows a temperature model of a susceptor based on a magnitude of a current, according to one embodiment.

The following operations 810 to 830 may be performed by an aerosol-generating device (e.g., the aerosol-generating device 1 of FIGS. 1 to 4). The aerosol-generating device may include a susceptor (e.g., the heater 18 of FIG. 1, the heater 182 of FIGS. 2 and 4, or the heater 183 of FIG. 3), a sensor unit (e.g., the sensor unit 13 of FIGS. 1 to 4), and a controller (e.g., the controller 12 of FIGS. 1 to 4). For example, operation 550 described with reference to FIG. 5 above may include operations 810 to 830.

According to one embodiment, the aerosol-generating device may include a first temperature sensor (e.g., the temperature sensor 131 of FIG. 4) disposed around the susceptor to measure a temperature, and may determine a temperature model of the susceptor based on a first sensor temperature sensed by the first temperature sensor. For example, the first temperature sensor may be disposed around the susceptor to obtain information about a rise or fall in the temperature of the susceptor. For example, the first temperature sensor may be an NTC temperature sensor.

In operation 810, the aerosol-generating device may obtain a first sensor temperature using the first temperature sensor disposed within a body of the aerosol-generating device. For example, the first sensor temperature may be measured at a timepoint at which a first value 920 is obtained.

In operation 820, the aerosol-generating device may correct the first value 920 based on the first sensor temperature to correspond to an electrical characteristic of the susceptor when the temperature of the susceptor is a first reference temperature 922. Since a magnitude of an eddy current indicated by the first signal having the first frequency may change in response to the temperature of the susceptor, the change in the magnitude of the eddy current due to external factors (e.g., external temperature, residual heat of the susceptor, or the like) may be corrected by correcting the first value 920 by the first sensor temperature.

For example, the electrical characteristic of the susceptor may be a magnitude of the eddy current, and the first reference temperature may be 25° C. As the temperature of the susceptor increases, the magnitude of the eddy current that appears in response to the first signal having the first frequency decreases. Therefore, when the magnitude of the eddy current indicated by the first signal is 900 when the first sensor temperature is 45° C., the magnitude of the eddy current may be corrected to 950 based on 25° C. When the magnitude of the eddy current indicated by the first signal is 930 when the first sensor temperature is 35° C., the magnitude of the eddy current may be corrected to 950 based on 25° C. When the magnitude of the eddy current indicated by the first signal is 1000 when the first sensor temperature is 0° C., the magnitude of the measured eddy current may be corrected to 950 based on 25° C. The values for the magnitude of the eddy current described above are arbitrarily described to exemplify the change in values, and are not limited to the described values.

According to one embodiment, the aerosol-generating device may correct a second value 910 based on the first sensor temperature to correspond to the electrical characteristic of the susceptor when the temperature of the susceptor is the first reference temperature 922. Since the magnitude of an eddy current indicated by the second signal having the second frequency may change in response to the temperature of the susceptor, the second value 910 may be corrected by the first sensor temperature. A degree to which the second value 910 is corrected by the first sensor temperature may be different from a degree to which the first value 920 is corrected by the first sensor temperature.

In operation 830, the aerosol-generating device may determine a first temperature model by considering the first value 920 as the electrical characteristic of the susceptor when the temperature of the susceptor is the first reference temperature 922, and by considering the second value 910 as the electrical characteristic of the susceptor when the temperature of the susceptor is the second reference temperature 912.

According to one embodiment, the electrical characteristic indicated in the susceptor by the first signal and the temperature of the susceptor may exhibit a linear relationship in an interval between the first value 920 (e.g., the first value a of FIG. 1) and the second value 910 (e.g., the second value b of FIG. 1). Referring to FIG. 9, the first temperature model defined between the first value 920 and the second value 910 may be expressed by [Equation 1] below.

$$T = ax + b \qquad [ Equation 1 ]$$

T denotes a temperature of the susceptor, x denotes the electrical characteristic of the susceptor, and a and b denote the coefficient and constant term of the first term in the temperature model corresponding to the susceptor, respectively. For example, when the first value 920 is considered as the electrical characteristic of the susceptor when the temperature of the susceptor is the first reference temperature 922, and the second value 910 is considered as the electrical characteristic of the susceptor when the temperature of the susceptor is the second reference temperature 912, the temperature model of the susceptor may be determined by determining a and b of the temperature model.

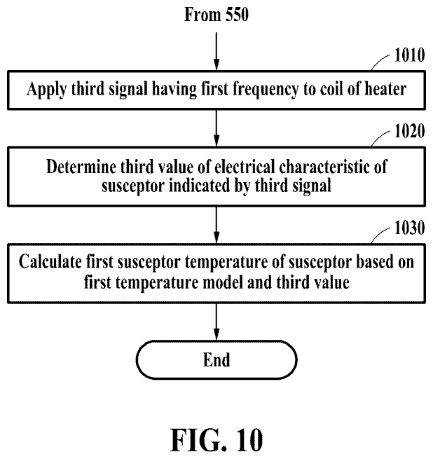

FIG. 10 is a flowchart of a method of calculating a temperature of a susceptor based on a temperature model of the susceptor, according to one embodiment.

The following operations 1010 to 1030 may be performed by an aerosol-generating device (e.g., the aerosol-generating device 1 of FIGS. 1 to 4). The aerosol-generating device may include a susceptor (e.g., the heater 18 of FIG. 1, the heater 182 of FIGS. 2 and 4, or the heater 183 of FIG. 3), a sensor unit (e.g., the sensor unit 13 of FIGS. 1 to 4), and a controller (e.g., the controller 12 of FIGS. 1 to 4). For example, operations 1010 to 1030 may be performed after operation 550 described above with reference to FIG. 5 is performed.

According to one embodiment, the aerosol-generating device may determine a temperature of the susceptor by using a first temperature model. For example, the aerosol-generating device may include a temperature sensing section at predetermined time intervals in a preheating section or heating section, and may perform an operation of determining a temperature of the susceptor in the temperature sensing section.

In operation 1010, the aerosol-generating device may apply a third signal having a first frequency to a coil of a heater so that an alternating magnetic field is generated. The third signal may be a signal for sensing a temperature of the susceptor and may have a preset current, voltage, and duty ratio. For example, the first frequency may be 290 kHz.

According to one embodiment, an operation of applying a first signal to the coil so that the temperature of the susceptor does not increase due to eddy currents induced in the susceptor by the third signal may be performed for a short time (e.g., several milliseconds).

According to one embodiment, a voltage of the first signal may be less than or equal to a preset voltage so that the temperature of the susceptor does not increase due to eddy currents induced in the susceptor by the third signal.

In operation 1020, the aerosol-generating device may determine a third value of an electrical characteristic of the susceptor indicated by the third signal. The description of operation 520 with reference to FIGS. 5 and 7 may be similarly applied to operation 1020 with modifications.

In operation 1030, the aerosol-generating device may calculate a first susceptor temperature of the susceptor based on the first temperature model and the third value. For example, the temperature of the susceptor may be calculated by substituting the third value corresponding to the electrical characteristic of the susceptor into an equation (e.g., [Equation 1]) corresponding to the first temperature model.

For example, the aerosol-generating device may perform heating of an aerosol-generating article for optimal smoking by controlling a signal applied to the coil of the heater so that a temperature of the susceptor corresponds to a preset temperature profile (e.g., the first temperature profile) based on the calculated temperature of the susceptor.

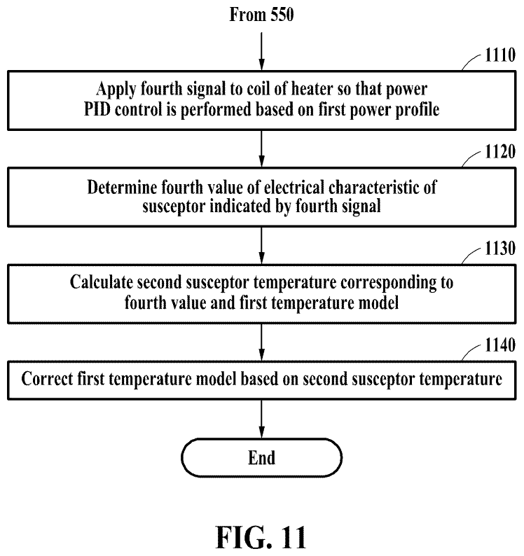

FIG. 11 is a flowchart of a method of updating a temperature model of a susceptor according to one embodiment.

The following operations 1110 to 1140 may be performed by an aerosol-generating device (e.g., the aerosol-generating device 1 of FIGS. 1 to 4). The aerosol-generating device may include a susceptor (e.g., the heater 18 of FIG. 1, the heater 182 of FIGS. 2 and 4, or the heater 183 of FIG. 3), a sensor unit (e.g., the sensor unit 13 of FIGS. 1 to 4), and a controller (e.g., the controller 12 of FIGS. 1 to 4). For example, operations 1110 to 1140 may be performed after operation 550 described above with reference to FIG. 5 is performed.

According to one embodiment, the aerosol-generating device may perform an operation for correcting a temperature model. For example, the aerosol-generating device may perform power PID control for heating the susceptor based on a power profile to correct the temperature model. The aerosol-generating device may precisely correct the temperature model of the susceptor based on a characteristic that the temperature of the susceptor converges to a particular target temperature when induction heating of the susceptor is performed corresponding to a specific power profile.

In operation 1110, the aerosol-generating device may apply a fourth signal to a coil of a heater so that power PID control is performed based on a first power profile. For example, the aerosol-generating device may perform induction heating of the susceptor at a first power based on the first power profile. For example, the first power may be 6 W. For example, the temperature of the susceptor that is inductively heated based on the first power profile for a predetermined period of time may converge to the first target temperature.

In operation 1120, the aerosol-generating device may determine a fourth value of an electrical characteristic of the susceptor indicated by a fourth signal. The description of operation 520 with reference to FIGS. 5 and 7 may be similarly applied to operation 1120 with modifications.

In operation 1130, the aerosol-generating device may calculate a second susceptor temperature corresponding to the fourth value and the first temperature model. For example, a temperature of the susceptor may be calculated by substituting a fourth value corresponding to the electrical characteristic of the susceptor into an Equation (e.g., [Equation 1]) corresponding to the first temperature model.

In operation 1140, the aerosol-generating device may correct the first temperature model based on the second susceptor temperature. For example, for the first temperature model expressed by a first-order function (e.g., [Equation 1]), a constant term (e.g., b in [Equation 1]) may be adjusted so that the second susceptor temperature matches a second target temperature.

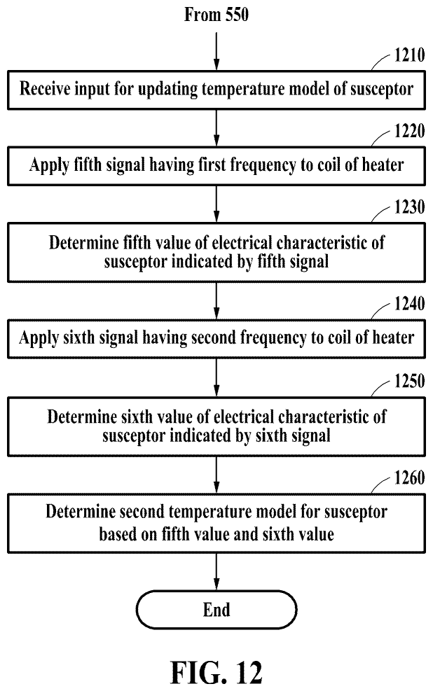

FIG. 12 is a flowchart of a method of determining a second temperature model for a susceptor according to one embodiment.

The following operations 1210 to 1260 may be performed by an aerosol-generating device (e.g., the aerosol-generating device 1 of FIGS. 1 to 4). The aerosol-generating device may include a susceptor (e.g., the heater 18 of FIG. 1, the heater 182 of FIGS. 2 and 4, or the heater 183 of FIG. 3), a sensor unit (e.g., the sensor unit 13 of FIGS. 1 to 4), and a controller (e.g., the controller 12 of FIGS. 1 to 4). For example, operations 1210 to 1260 may be performed after operation 550 described above with reference to FIG. 5 is performed.

According to one embodiment, the aerosol-generating device may determine a new temperature model (e.g., a second temperature model) in response to an input for updating the temperature model. For example, when a previously determined first temperature model may no longer be used, such as due to replacement of a susceptor, the method of determining a temperature model may be performed again, thereby determining a second temperature model.

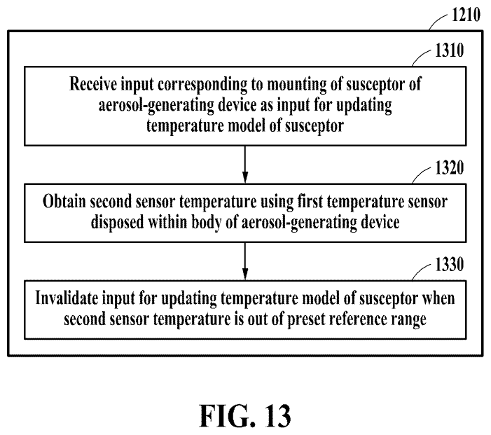

In operation 1210, the aerosol-generating device may receive an input for updating the temperature model of the susceptor. For example, the aerosol-generating device may receive an input corresponding to mounting of the susceptor as an input for updating a temperature model of the susceptor. For example, the aerosol-generating device may receive an input from a user performing device calibration as an input for updating a temperature model of the susceptor. A method of receiving an input for updating a temperature of the susceptor is described in detail below with reference to FIG. 13.

In operation 1220, the aerosol-generating device may apply a fifth signal having a first frequency to a coil of a heater so that an alternating magnetic field is generated.

In operation 1230, the aerosol-generating device may determine a fifth value of an electrical characteristic of the susceptor indicated by the fifth signal.

In operation 1240, the aerosol-generating device may apply a sixth signal having a second frequency to the coil of the heater so that an alternating magnetic field is generated.

In operation 1250, the aerosol-generating device may determine a sixth value of the electrical characteristic of the susceptor indicated by the sixth signal.

In operation 1260, the aerosol-generating device may determine a second temperature model for the susceptor based on the fifth value and the sixth value.

The description of operations 510 to 550 with reference to FIGS. 5 to 9 may be similarly applied to operations 1220 to 1260 with modifications.

FIG. 13 is a flowchart of a method of receiving an input to update a temperature model of a susceptor, according to one embodiment.

The following operations 1310 to 1330 may be performed by an aerosol-generating device (e.g., the aerosol-generating device 1 of FIGS. 1 to 4). The aerosol-generating device may include a susceptor (e.g., the heater 18 of FIG. 1, the heater 182 of FIGS. 2 and 4, or the heater 183 of FIG. 3), a sensor unit (e.g., the sensor unit 13 of FIGS. 1 to 4), and a controller (e.g., the controller 12 of FIGS. 1 to 4). For example, operation 1210 described above with reference to FIG. 12 may include operations 1310 to 1330.

In operation 1310, the aerosol-generating device may receive an input corresponding to the mounting of the susceptor of the aerosol-generating device as an input for updating a temperature model of the susceptor. For example, when a susceptor is separated from the aerosol-generating device and then the same susceptor is remounted, or when an existing susceptor is detached from the aerosol-generating device and a new susceptor is mounted, an input corresponding to the mounting of the susceptor may be generated.

In operation 1320, the aerosol-generating device may obtain a second sensor temperature by using a first temperature sensor disposed within a body of the aerosol-generating device. For example, the second sensor temperature may be measured at a timepoint at which an input for updating the temperature model of the susceptor is received. For example, the first temperature sensor may be disposed around the susceptor to obtain information about a rise or fall in the temperature of the susceptor. For example, the first temperature sensor may be an NTC temperature sensor.

In operation 1330, the aerosol-generating device may invalidate an input for updating the temperature model of the susceptor when the second sensor temperature is out of a preset reference range. For example, the preset reference range for the second sensor temperature may be a range of 0° C. to 50° C. For example, the aerosol-generating device may invalidate an input for updating the temperature model when the temperature of the susceptor is out of the preset reference range, since the second temperature model may be determined inaccurately.

For example, the aerosol-generating device may determine that the susceptor has been separated and then remounted due to heating of the aerosol-generating device when the second sensor temperature is out of a preset reference range. When the same susceptor is separated and then remounted, an input for updating the temperature model of the susceptor may be invalidated since the first temperature model may be used as is to determine the temperature of the susceptor.

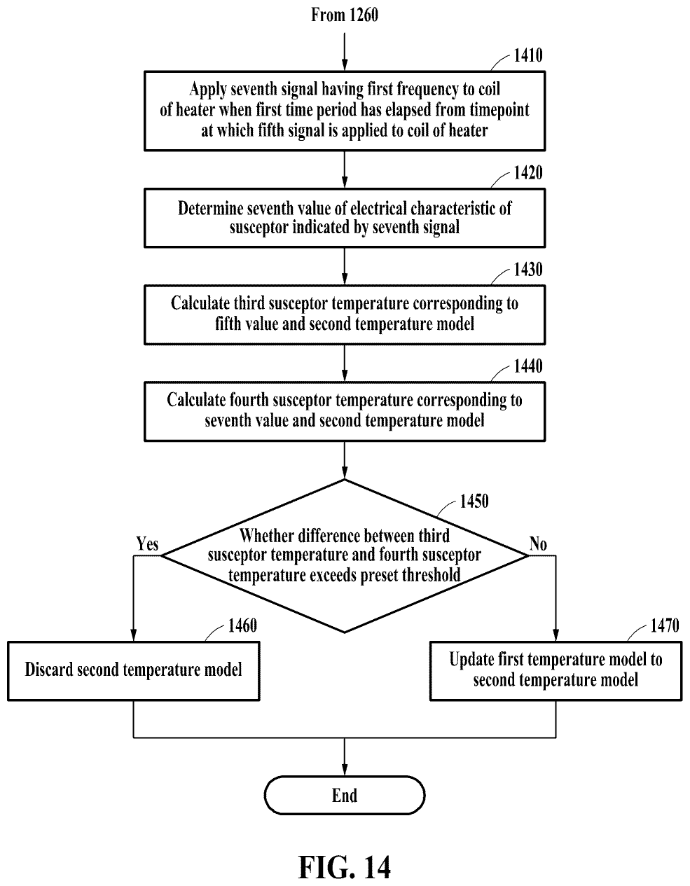

FIG. 14 is a flowchart of a method of discarding a second temperature model or updating a first temperature model to the second temperature model, according to one embodiment.

The following operations 1410 to 1470 may be performed by an aerosol-generating device (e.g., the aerosol-generating device 1 of FIGS. 1 to 4). The aerosol-generating device may include a susceptor (e.g., the heater 18 of FIG. 1, the heater 182 of FIGS. 2 and 4, or the heater 183 of FIG. 3), a sensor unit (e.g., the sensor unit 13 of FIGS. 1 to 4), and a controller (e.g., the controller 12 of FIGS. 1 to 4). For example, operations 1410 to 1470 may be performed after operation 1260 described above with reference to FIG. 12 is performed.

According to one embodiment, the aerosol-generating device may perform an operation of verifying a newly determined second temperature model. When a second temperature model is determined to be accurate, an aerosol-generating model may update a first temperature model to the second temperature model, and when the second temperature model is determined to be inaccurate, the second temperature model may be discarded and the first temperature model may be used.

In operation 1410, the aerosol-generating device may apply a seventh signal having a first frequency to a coil of a heater when a first time period has elapsed from a timepoint at which a fifth signal is applied to the coil of the heater. The description of operation 510 with reference to FIG. 5 may be similarly applied to operation 1410 with modifications.

In operation 1420, the aerosol-generating device may determine a seventh value of an electrical characteristic of the susceptor indicated by a seventh signal. The description of operation 520 with reference to FIGS. 5 and 7 may be similarly applied to operation 1420 with modifications.

In operation 1430, the aerosol-generating device may calculate a third susceptor temperature corresponding to a fifth value and the second temperature model. For example, the third susceptor temperature may be calculated by substituting a fifth value corresponding to the electrical characteristic of the susceptor into an equation corresponding to the second temperature model.

In operation 1440, the aerosol-generating device may calculate a fourth susceptor temperature corresponding to the seventh value and the second temperature model. For example, the fourth susceptor temperature may be calculated by substituting the seventh value corresponding to the electrical characteristic of the susceptor into an equation corresponding to the second temperature model.

In operation 1450, the aerosol-generating device may determine whether a difference between the third susceptor temperature and the fourth susceptor temperature exceeds a preset threshold. For example, when the difference between the third susceptor temperature and the fourth susceptor temperature exceeds the preset threshold, the aerosol-generating device may determine that the second temperature model is determined incorrectly or that the heated susceptor has cooled for a first time period after being separated and remounted. For example, when the difference between the third susceptor temperature and the fourth susceptor temperature does not exceed the preset threshold, the aerosol-generating device may determine that the second temperature model is determined while the temperature of the susceptor is stable.

In operation 1460, when the difference between the third susceptor temperature and the fourth susceptor temperature exceeds the preset threshold, the aerosol-generating device may discard the second temperature model. When the second temperature model is determined incorrectly or the heated susceptor has cooled for a first time period after being separated and remounted, the aerosol-generating device may discard the second temperature model and use the existing first temperature model to determine the temperature of the susceptor in a temperature sensing section.

In operation 1470, when the difference between the third susceptor temperature and the fourth susceptor temperature does not exceed the preset threshold, the aerosol-generating device may update the first temperature model to the second temperature model. When the second temperature model is determined while the temperature of the susceptor is stable, the aerosol-generating device may update the first temperature model to the second temperature model and determine the temperature of the susceptor in the temperature sensing section using the second temperature model.

According to one embodiment, the aerosol-generating device may correct the temperature model by performing operations 1110 to 1140 described above with reference to FIG. 11 for the updated second temperature model. For example, the operation of correcting the second temperature model may be performed after the second temperature model is determined and the aerosol-generating device is rebooted.

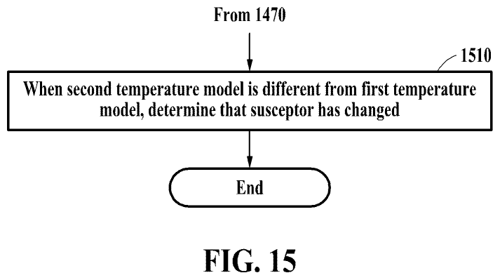

FIG. 15 is a flowchart of a method of detecting change of a susceptor according to one embodiment.

The following operation 1510 may be performed by an aerosol-generating device (e.g., the aerosol-generating device 1 of FIGS. 1 to 4). The aerosol-generating device may include a susceptor (e.g., the heater 18 of FIG. 1, the heater 182 of FIGS. 2 and 4, or the heater 183 of FIG. 3), a sensor unit (e.g., the sensor unit 13 of FIGS. 1 to 4), and a controller (e.g., the controller 12 of FIGS. 1 to 4). For example, operation 1510 may be performed after operation 1470 described above with reference to FIG. 14 is performed.

In operation 1510, when a second temperature model is different from a first temperature model, the aerosol-generating device may determine that a susceptor has changed. When a difference between a third susceptor temperature and a fourth susceptor temperature is less than or equal to a preset threshold, the second temperature model is determined while the temperature of the susceptor is stable, and therefore the temperature model for determining the temperature of the susceptor may be updated to the second temperature model. Since the temperature model of the susceptor is determined corresponding to the susceptor, when the updated second temperature model is different from the existing first temperature model, the aerosol-generating device may determine that the susceptor has changed. For example, when the first temperature model and the second temperature model are expressed as first-order functions (e.g., [Equation 1]), and a coefficient (e.g., a in [Equation 1]) of a first-order term and a coefficient (e.g., b in [Equation 1]) of a constant term of the first temperature model are different from a coefficient of a first-order term and a coefficient of a constant term of the second temperature model, the aerosol-generating device may determine that the susceptor has changed.

Certain embodiments or other embodiments of the present disclosure described above may not be mutually exclusive or distinct from each other. Certain embodiments or other embodiments of the present disclosure described above may be combined or used in combination with each other in their respective configurations or functions.

For example, a configuration A described in a particular embodiment and/or drawing may be combined with a configuration B described in another embodiment and/or drawing. That is, even if a combination between configurations is not directly described, it is to be understood that a combination is possible, except in cases where a combination is described as not possible.

The above detailed description should not be construed as restrictive in all respects but should be considered as illustrative. The scope of the invention should be determined by a reasonable interpretation of the appended claims, and all modifications within the equivalent scope of the invention are intended to be included in the scope of the invention.

What is claimed is:

1. A method, performed by an aerosol-generating device, of determining a temperature model of a susceptor, the method comprising:
applying a first signal having a first frequency to a coil of a heater so that an alternating magnetic field is generated;
determining a first value of an electrical characteristic of a susceptor indicated by the first signal;
applying a second signal having a second frequency to the coil of the heater so that an alternating magnetic field is generated;
determining a second value of the electrical characteristic of the susceptor indicated by the second signal; and
determining a first temperature model for the susceptor based on the first value and the second value,
wherein the first temperature model is a model used for determining a temperature of the susceptor based on the electrical characteristic of the susceptor.

2. The method of claim 1, further comprising:
applying a third signal having the first frequency to the coil of the heater so that an alternating magnetic field is generated;
determining a third value of the electrical characteristic of the susceptor indicated by the third signal; and
calculating a first susceptor temperature of the susceptor based on the first temperature model and the third value.

3. The method of claim 1, wherein
the first temperature model is represented by [Equation 1] below,
T=ax+b [Equation 1]
wherein T denotes a temperature of the susceptor, and x denotes the electrical characteristic of the susceptor.

4. The method of claim 3, wherein the determining of the first temperature model of the susceptor comprises,
determining a and b of [Equation 1] by considering the first value as the electrical characteristic of the susceptor when a temperature of the susceptor is a first reference temperature, and by considering the second value as the electrical characteristic of the susceptor when a temperature of the susceptor is a second reference temperature.

5. The method of claim 1, wherein the determining of the first value of the electrical characteristic of the susceptor comprises,
determining the first value based on at least one of a current, voltage, or power of a first output signal at an output end of the coil of the heater.

6. The method of claim 5, wherein
the electrical characteristic of the susceptor is an eddy current.

7. The method of claim 4, wherein the determining of the first temperature model of the susceptor comprises:
obtaining a first sensor temperature by using a first temperature sensor disposed within a body of the aerosol-generating device; and
correcting the first value based on the first sensor temperature to correspond to the electrical characteristic of the susceptor when a temperature of the susceptor is a first reference temperature.

8. The method of claim 1, further comprising:
applying a fourth signal to the coil of the heater so that power proportional-integral-differential (PID) control is performed based on a first power profile;
determining a fourth value of the electrical characteristic of the susceptor indicated by the fourth signal;
calculating a second susceptor temperature corresponding to the fourth value and the first temperature model; and
correcting the first temperature model based on the second susceptor temperature.

9. The method of claim 1, further comprising:
receiving an input for updating a temperature model of the susceptor;
applying a fifth signal having the first frequency to the coil of the heater;
determining a fifth value of the electrical characteristic of the susceptor indicated by the fifth signal;
applying a sixth signal having the second frequency to the coil of the heater so that an alternating magnetic field is generated;
determining a sixth value of the electrical characteristic of the susceptor indicated by the sixth signal; and
determining a second temperature model for the susceptor based on the fifth value and the sixth value.

10. The method of claim 9, wherein the receiving of the input for updating the temperature model of the susceptor comprises,
receiving an input corresponding to a mounting of the susceptor of the aerosol-generating device as an input for updating a temperature model of the susceptor.

11. The method of claim 10, wherein the receiving of the input for updating the temperature model of the susceptor further comprises:
obtaining a second sensor temperature by using a first temperature sensor disposed within a body of the aerosol-generating device; and
invalidating the input for updating the temperature model of the susceptor when the second sensor temperature is out of a preset reference range.

12. The method of claim 9, further comprising:
when a first time period has elapsed from a timepoint at which the fifth signal is applied to the coil of the heater, applying a seventh signal having the first frequency to the coil of the heater so that an alternating magnetic field is generated;
determining a seventh value of the electrical characteristic of the susceptor indicated by the seventh signal;
calculating a third susceptor temperature corresponding to the fifth value and the second temperature model;
calculating a fourth susceptor temperature corresponding to the seventh value and the second temperature model;
discarding the second temperature model when a difference between the third susceptor temperature and the fourth susceptor temperature exceeds a preset threshold; and
updating the first temperature model to the second temperature model when a difference between the third susceptor temperature and the fourth susceptor temperature is less than or equal to a preset threshold.

13. The method of claim 12, further comprising:
when a difference between the third susceptor temperature and the fourth susceptor temperature is less than or equal to the preset threshold, and the second temperature model is different from the first temperature model, determining that the susceptor has changed.

14. A non-transitory computer-readable storage medium storing instructions that, when executed by a processor, cause the processor to perform the method of claim 1.

15. An aerosol-generating device, comprising:
an induction coil configured to generate an alternating magnetic field; and
a controller configured to control the aerosol-generating device,
wherein the controller is further configured to,
apply a first signal having a first frequency to a coil of a heater so that an alternating magnetic field is generated,
determine a first value of an electrical characteristic of a susceptor indicated by the first signal,
apply a second signal having a second frequency to the coil of the heater so that an alternating magnetic field is generated,
determine a second value of the electrical characteristic of the susceptor indicated by the second signal, and
determine a first temperature model for the susceptor based on the first value and the second value,
wherein the first temperature model is a model used for determining a temperature of the susceptor based on the electrical characteristic of the susceptor.
